(19) United States
(12) Patent Application Publication
(10) Pub. No.: US 2025/0061515 A1
(43) Pub. Date: Feb. 20, 2025

(54) INTEGRATED SYSTEM AND METHOD FOR TRACKING AND MANAGING FINANCIAL AND INSURANCE CLIENTS AND ASSOCIATED DATA AND GENERATING FINANCIAL PROPOSALS

(71) Applicant: BHIP, LLC, Las Vegas, NV (US)

(72) Inventors: Todd Howell, Henderson, NV (US); Lance Burbank, Henderson, NV (US)

(21) Appl. No.: 18/234,541

(22) Filed: Aug. 16, 2023

(51) Int. Cl. G06Q 40/06

(52) U.S. Cl. CPC G06Q 40/06

(57) ABSTRACT

An integrated system for tracking clients, including client information and status, as well as client financial and insurance information, and generating proposals, comprises a management platform with at least one server for receiving and storing information regarding a plurality of clients, including client identity information, client status information and client financial information regarding a plurality of client financial accounts, for causing a display device of a user device to display a graphical user interface indicating a plurality of client phases and an indication of each client with a respective one of the phases based upon the client status information for each client, and for implementing a financial engine configured to generate and cause a user device to display a graphical user interface comprising at least one graphical indicator of financial amounts associated with the plurality of accounts of the client.

### FIELD OF THE INVENTION

The present invention relates to systems and methods for managing clients and client information.

### BACKGROUND OF THE INVENTION

Businesses commonly utilize a variety of systems for managing clients, communicating with clients, storing and managing client information, and generating client-related information. For example, a business may utilize one application to manage client information. These programs are often simplistic databases which simply allow a user to store client information and then access that information for future use. The systems may also include functionality for inputting and triggering reminders and the like. However, the business generally then utilizes an entirely different program, such as Microsoft Outlook, to generate client communications such as emails, using the information and reminders generated by the client management program.

Still further, the business may utilize an entirely different system or application to store client information. For example, the business may utilize a program to store and access client files in electronic format.

Yet further, the business may utilize one or more systems or applications to generate client-related information or work product. As a simple example, the business might utilize Microsoft Word to generate documents. The business might use a variety of other applications, depending upon the nature of the business. For example, in the financial industry, the business might use various financial generation tools to generate client financial models

Obviously, this environment has various drawbacks. Foremost is the problem that the business is forced to utilize a variety of different systems or applications for different aspects of the business, where those systems and applications are disparate. This leads to loss of productivity moving between the different systems or applications. Further, a company might have thousands of client or potential clients and need a technological solution to real-time tracking, updating and information generation capabilities relative to those clients. Lastly, these systems may not suitably allow the business to track a client from intake through rendering of services because the different systems or applications don't communicate and provide a comprehensive picture of the client within the context of the business.

A solution to these and other problems with existing systems is desired.

### SUMMARY OF THE INVENTION

Aspects of the invention comprise methods and systems for collecting, storing and presenting client information, and particularly client financial and insurance-related information, including managing client status.

In one embodiment, the invention comprise an integrated client tracking and finance generation system comprising a management platform comprising at least one server and a data storage device, the server comprising a communication interface for establishing a communication link with at least one user device having a display device, the management platform further comprising a processor, a memory and machine readable code stored in the memory and executable by the processor to cause the server to receive information regarding a plurality of clients, the information comprising, as to each of the plurality of clients, client identity information, client status information and client financial information regarding a plurality of client financial accounts, to store, in a database associated with the data storage device, the information regarding the plurality of clients, in electronic format, to generate information for causing the display device of the user device to display a graphical user interface indicating a plurality of client phases and an indication of each client with a respective one of the phases based upon the client status information for each client, and implement a financial engine configured to receive input of a selection of at least one of the clients, access financial data regarding the plurality of financial accounts of the client, and generate information for causing the display device of the user device to display a graphical user interface comprising at least one graphical indicator of financial amounts associated with the plurality of accounts of the client.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an environment of a system of the present invention;

FIG. 2 is a flow diagram illustrating a method in accordance with one embodiment of the invention;

FIG. 3 illustrates a first graphical interface in accordance with an example of the invention;

FIG. 4 illustrates a second graphical interface in accordance with an example of the invention;

FIG. 5 illustrates a third graphical interface in accordance with an example of the invention;

FIG. 6 illustrates a fourth graphical interface in accordance with an example of the invention; and

FIGS. 7A-C illustrates a database structure in accordance with an example of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

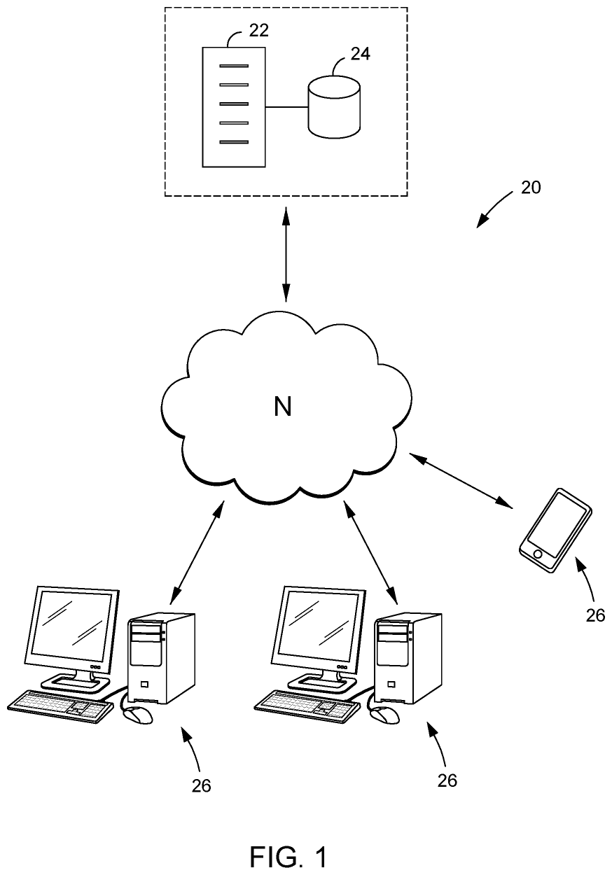

FIG. 1 illustrates an environment of the invention, which includes an integrated client management system 20. The integrated client management system 20 may include at least one server 22 which comprises one or more processors or controllers, at least one communication device or interface, a data storage device 24 such as for storing one or more databases, and one or more additional memory or data storage devices (such as separate from the database), such as for storing machine-readable code (i.e. “software”). In one or more embodiments, the processor(s) is configured to execute one or more instructions, such as in the form of the machine readable code/software, to allow the server 22 to perform various functions. The software is preferably non-transitory, such as by being fixed in a tangible medium, such as the above-referenced memory device. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine-readable code.

Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the server 22 may include (or be linked communicatively at one or more times to) one or more user devices 26. The user devices 26 might comprise, for example, desktop or laptop computers which include a processor, a memory, computer readable code stored in the memory and executable by the processor, and or more input and/or output devices such as a keyboard, mouse, touchscreen, video display or the like, and one or more communication interfaces.

The user devices 26 might also comprise mobile communication devices (phones, PDAs, tablets) or other devices. These devices may also include a processor, a memory, machine-readable code stored in the memory and executable by the processor, one or more user inputs devices (such as a video display having a touch-screen) and a communication interface.

The server 22 and the user devices 26 may communicate with one another via their communication interfaces via one or more communication links. While these communication links could be direct (such as via a wireless communication link between Bluetooth communication interfaces of the devices), the communication links may comprise various networks N, such as which utilize wireless (e.g. cellular, Wi-Fi, Bluetooth, etc.) or wired networks (the Internet, LANs, WANs, etc.) or combinations thereof.

In one embodiment, the processor and other elements of the server 22 may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the server 22 to communicate with the one or more user devices 26.

As one example, the server 22 may be configured as a webserver, such as by which information is exchanged between the server 22 and a web browser running in the user deice 26. As another example, the user device 26 may run an application, such as downloaded to and stored in an associated memory, which facilitates the exchange of data/information.

As indicated above, the processor of the server 22 is configured to execute machine-readable code for implementing functionality of the invention. In one embodiment, the software may comprise one or more modules. The server 22 may be configured to implement a variety of functionality, including one or more of: 1) receiving and storing client information, including client identity and financial-related information; 2) generating and displaying one or more financial proposals; 3) generating and displaying client status information, where that status information is variable and changes over time; 4) generating and transmitting client communications; and 5) generating client policy information and the status thereof, where that status is variable and changes over time.

In one embodiment of the invention, the machine-readable code of the server 22 is configured to transform data into visual information, such as displayed by a graphical user interface. The machine-readable code is also configured to cause graphically generated and displayed information to change or transform.

These and other aspects of the invention will be appreciated from a description of an example of the invention.

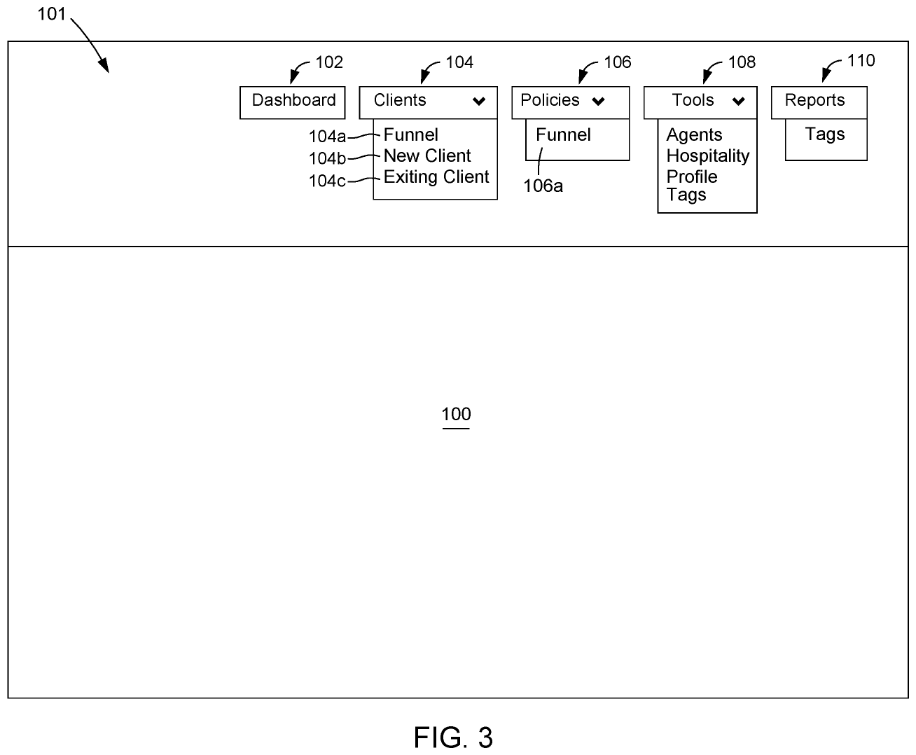

In one embodiment, referring to FIG. 3, in a step S1, a user (such as an agent) may login to the system 22. This may comprise, for example, the server 22 causing a user device 26 to display (on a video display thereof) a graphical login interface. The login interface may allow, for example, the user to enter login information such as a username and password (or to create an account and then login using such information, as is known).

In a step S2, the server 22 may cause the user device 28 to display a dashboard, such as in the form of a graphical user interface which displays information, including one or more selectable options. One example of such a dashboard is illustrated at P1 of Appendix A attached hereto. As illustrated in FIG. 1, the dashboard 100 may be configured to display a main menu 101 which includes a number of selectable options, such as one or more menu items that may be selected by the user to cause the server 22 to cause their user device 26 to display other graphical user interfaces or information. In one example, the main menu 101 may be displayed in association with all displayable user interfaces, thus providing common navigation selections from the different interfaces.

The menu-selectable options may include options relating to the Dashboard 102 (such as to cause, from any displayed interface, the Dashboard 100 to be redisplayed), Clients 104 (such as options for displaying a client funnel, adding a new client and showing information regarding existing clients), Policies 106 (such as for displaying a policy funnel, as detailed below), Tools 108 (as described in further detail below) and Reports 110.

As illustrated in P1 of Appendix A, the dashboard may also display summary information relating to the user. As illustrated, that information may comprise reminders that are due, statistical information regarding customers that the agent has successfully won business from (or lost), the types of financial accounts corresponding to “won” clients, and information regarding a number of clients in each of a plurality of different phases (as described in more detail below).

In a step S3, client information may be provided to the server 22, such as for storage in one or more databases, such as stored in the data storage device 24. In one embodiment, client information might be collected by the server 22 or may be provided to the server 22. As described below, the client information may comprise a wide variety of information about or associated with a client, such as client identity information and client financial information.

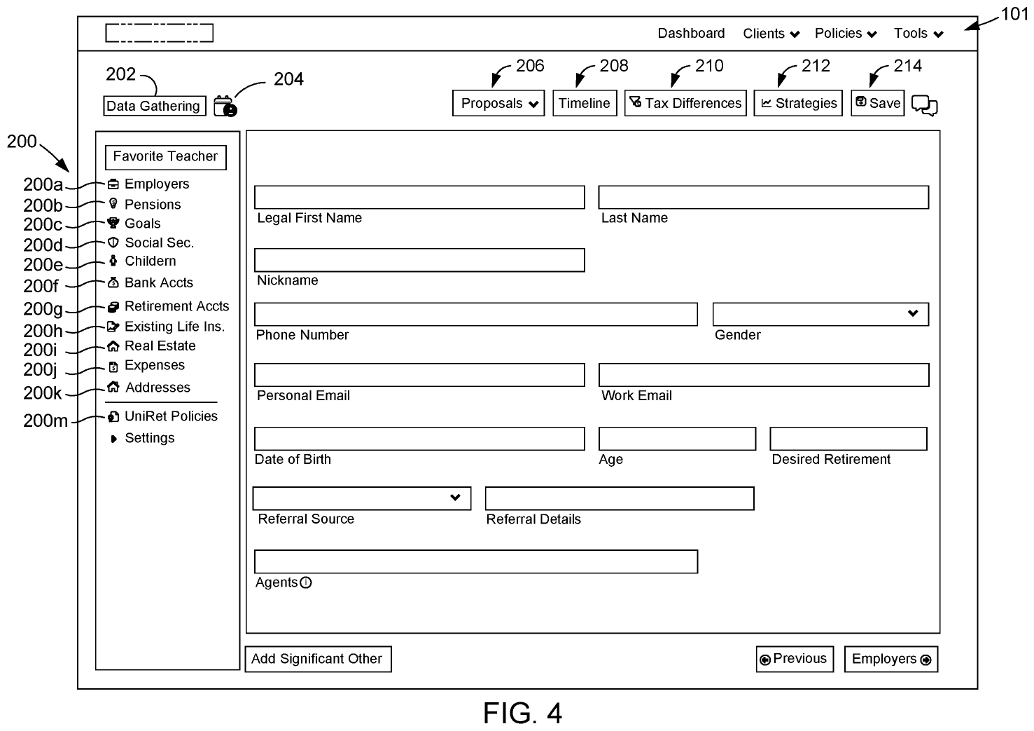

In one example, client information may be input by a user (such as an agent, or in some cases, a client themselves) of the system 20, such as via a user device 26, via one or more graphical user interfaces. As one example, a user might select a “NEW CLIENT” option 104b displayed via the main menu 101. In response, the server 22 may cause the user device 26 to display a “Client Details” graphical user interface. One specific example of such an interface is illustrated at P2 of Appendix A. As illustrated, the Client Details interface may display a plurality of input fields for accepting a variety of client information, such as client name and contact information. As illustrated in FIG. 3, client-related interfaces may include the main menu 101, and specific client-related elements. For example, as illustrated in FIG. 4, each of the client-related interfaces may display a client menu 200 of selectable options, a client phase indicator and associated selector 202, a client appointments/reminder option 204, a Proposals option 206, a Timelines option 208, a Tax Differences option 210, a Strategies option 212 and a Save option 214. Each of these elements might be configured as a selectable object as displayed on the related client interface.

In the event the client has a significant other, such as a spouse, partner or the like, the user may select an “Add Significant Other” option, such as displayed on the Client Details interface, to cause another graphical user interface to be displayed for accepting information into various displayed fields relating to the client's significant other.

In one example, the user may input other client information, such as by other displayed graphical user interfaces. The server 22 might cause the interfaces to be automatically displayed, such as in response to the completion of the input of information to a previous page (such as by providing information relative to all fields that are designated as “required”) or by user selection of an option. For example, as detailed above, and illustrated in FIG. 4 and at P2 of Appendix A, the client-related interfaces (including the Client Details interface) may include a plurality of selectable options, such as “Employers” 200a, “Pensions” 200b, “Goals” 200c, “Social Security” 200d, Children” 200e, “Bank Accounts” 200f, “Retirement Accounts” 200g, “Existing Life Insurance” 200h, “Real Estate” 200i, “Expenses” 200j and “Addresses” 200k, and/or others. The user's selection of any of these options may cause the server 22 to cause the user's device 26 to display an associated graphical user interface. Like the “Client Details” graphical user interface, such interfaces may display a variety of information and include a number of user input fields for accepting information from the user.

For example, P3 of Appendix A comprises an example “Employer Details” graphical user interface which may be displayed by selection of the “Employer Details” option 200a. P4 of Appendix A comprises an example “Pension Details” graphical user interface which may be displayed by selection of the “Pensions” option 200b. P5 of Appendix A comprises an example “Client Goals” graphical user interface which may be displayed by selection of the “Goals” option 200c. P6 of Appendix A comprises an example “Social Security Details” graphical user interface which may be displayed by selection of the “Social Security” option 200d. P7 of Appendix A comprises an example “Child Details” graphical user interface which may be displayed by selection of the “Children” option 200e. P8 of Appendix A comprises an example “Bank Account Details” graphical user interface which may be displayed by selection of the “Bank Accts” option 200f. P9 of Appendix A comprises an example “Retirement Account Details” graphical user interface which may be displayed by selection of the “Retirement Accts” option 200g. P10 of Appendix A comprises an example “Existing Life Ins. Details” graphical user interface which may be displayed by selection of the “Existing Life Ins” option 200h. P11 of Appendix A comprises an example “Real Estate Details” graphical user interface which may be displayed by selection of the “Real Estate” option 200i. P12 of Appendix A comprises an example “Expense Details” graphical user interface which may be displayed by selection of the “Expenses” option 200j, and P13 of Appendix A comprises an example “Address Details” graphical user interface which may be displayed by selection of the “Addresses” option 200k.

In one embodiment, when a user elects to create a new client, a new client account is generated by the server 22. The provided client information may then be stored in the database in the data storage device 24 so that it is accessible with reference to the client. As detailed below, the client information is preferably also linked to other elements in the database.

Of course, the system 20 may be configured to collect other information regarding a client, including via the display of other graphical user interfaces. Further, as described in more detail below, in some preferred embodiments, the system 20 may be configured to store client information access data (such as external financial account information and associated account access information such as user name and login information) which permits the system 20 to collect, in real-time, information regarding a client. Such information may comprise, for example, real-time retirement account balance information, bank account information or the like, such as from one or more external vendor or financial systems.

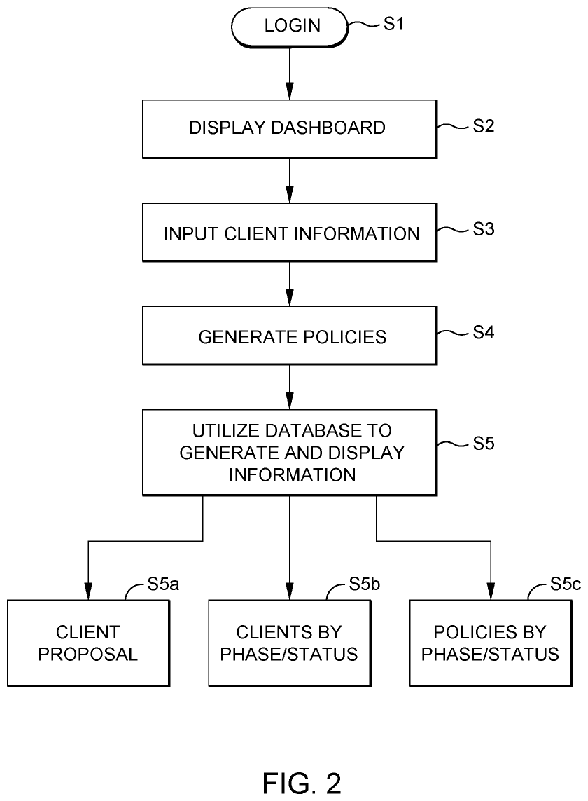

Referring to FIG. 2, in a step S4, the server 22 may be configured to generate and cause the user's device to display a “Policies” graphical user interface, such as in response to the selection of a “Policies” option displayed on the client page. In one configuration, this graphical user interface allows a user to input information regarding a new financial/insurance policy in association with the client. One example of such an interface is P14 of Appendix A.

Referring again to FIG. 2, in a step S5, the server 22 may utilize information in the database to generate various information and cause that information to be displayed on a user device 26.

For example, in one embodiment, the server 22 may be configured to generate and cause the user's device 26 to display a “Timeline” graphical interface, such as in response to the selection of a “Timeline” option. In one configuration, a user may input information regarding a client timeline, such as an current age and a desired retirement age. This information may be collected, for example, relative to one or more of the client information interfaces and is then stored in the database. The server 22 may then utilize this information to cause the display of graphical visual information which represents this information. P15 of Appendix A illustrates one example of such a graphical visual representation.

In one embodiment, the server 22 may be configured to generate and cause the user's device 26 to display a “Tax Differences” graphical interface, such as in response to the selection of a “Tax Differences” option 210 (see FIG. 4) displayed on the client page. See page P16 of Appendix A.

In one embodiment, the server 22 may be configured to generate and cause the user's device 26 to display a “Strategies” graphical interface, such as in response to the selection of a “Strategies” option 212 displayed on the client page. See page P17 of Appendix A.

In one embodiment, as indicated at step S5a of FIG. 2, the server 22 may be configured to generate and cause the user's device 26 to display a “Proposals” graphical user interface, such as in response to the selection of a “Proposals” option 206 displayed on the client page. In one configuration, this graphical user interface is configured to display financial data, such as projected account balance, income streams and the like, such as based upon the financial data provided by the client. As indicated above this may comprise information collected from the client regarding bank accounts, retirement accounts, annuities or other financial vehicles, pensions and the like.

In this regard, in one embodiment, the system 20 may be configured to implement a financial analysis engine which utilizes client financial information which is stored in the one or more databases associated with the data storage device 24, to generate a visual interface of generated financial information which can be viewed by the user (in one configuration, the information may be generated by an agent user of the system 20, such as for presentation (viewing/discussion) with a client user of the system 20, such as in real time.

In one embodiment, for example, the financial analysis engine may utilize the collected and stored client financial information to generate, and preferably create a visual representative output, of client finances. In one configuration, this may comprise annual income, such as by age. It may also comprise nest-egg amounts, such as lump-sum savings, residual amounts after death (life insurance amounts or the like). For example, as illustrated at P18 of Appendix A, the financial engine may utilize the stored client financial information from different sources, as collected by or input into the system 20 for that client. As indicated above, these different sources might comprise pensions, bank accounts, life insurance, retirement accounts or other financial vehicles. The financial engine may access that information from the database and generate one or more visual representations of client finances, such as visual representations of client income, such as annually from present through a retirement age.

In one configuration, the client finance information may be displayed via a graphical interface which includes graphical elements. Further, the graphical interface may include selectors (or otherwise permit user input) to allow the user to modify aspects of the generated information. For example, as illustrated, when a client has multiple sources of income, annual income may comprise an aggregation of income from multiple sources. In one embodiment, a user may be permitted to control which sources of income are used to generate the client finance information. For example, the user may be permitted to select or de-select individual income sources, thus causing the financial engine to modify the associated generated information, including the visual representation. See, for example, P18 vs. P19 in Appendix A, wherein P18 is an interface displaying information based upon a first set of accounts, and P19 is an interface displaying information based upon a subset of the accounts from P18. In one embodiment, as illustrated, income from different sources might be visually represented in different manners.

An aspect of the invention thus comprises the ability of the user to generate, in real-time, client financial information from the client-stored financial data, such as for display (such as via a user device 26 or by printing) to the client. Further, the user may modify the displayed information based upon selected criteria, such as to show the client different financial scenarios—in real time.

In situations where the client has linked members (like a spouse/children), then the linked financial data may also be utilized by the financial engine, or the user may de-select that information, such as to only show financial information for the client. For example, the user might elect to show retirement income and/or nest-egg information for either the husband or wife, or both. In each case, each individual source of income or funds may, as noted herein, be individually indicated and selected or de-selected.

In one embodiment, as indicated at step S5b, the system 20 is configured to track and provide information regarding a status of a particular client or policy, and to provide a visual indication of the same. In one embodiment, the status of a client or policy is with reference to a designated phase, which may be time based or, more preferably, is reflective of a processing status of that client or policy. For example, relative to a client, the different phases might comprise a “Prospect” phase, a “Gathering Data” phase, an “Analyze” phase, a “Follow Up” phase, an “Applicant Submitted” phase, a “Delivery” phase, and a “Drip Campaign” phase.

In one embodiment, the user may designate and change, the status of a client. For example, as described above and illustrated in FIG. 4, one or more of the client-related interfaces may display the client status and change option 202. This option 202 might include, for example, a drop-down menu that allows the user to change the status of the particular client via selection of one of the phase options. The currently indicated phase or status may then be displayed by that option 202 on each of the client-related pages.

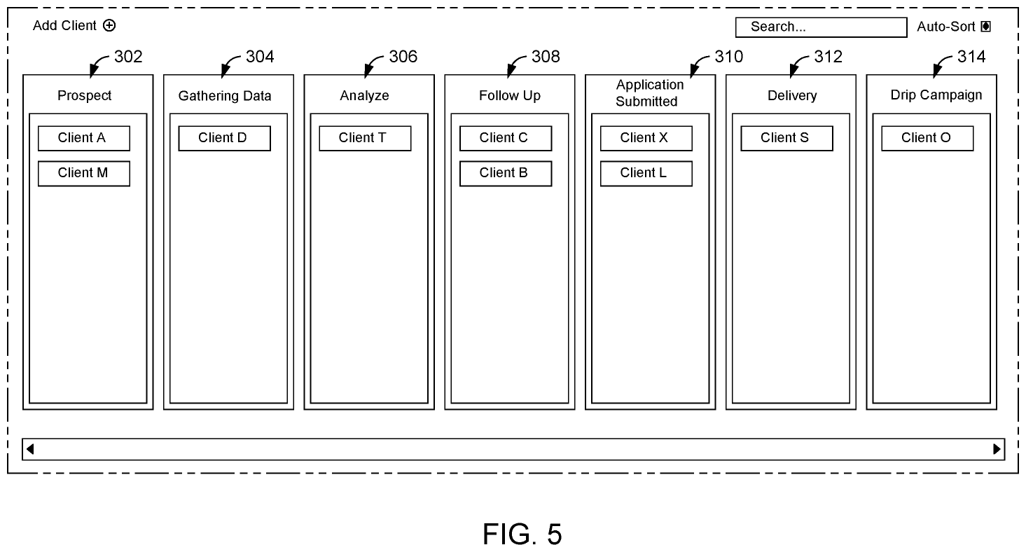

Most preferably, the system 20 is configured to generate and cause a user's device 26 to display a graphical indication of the status or phase of multiple clients in a single view. This view might be displayed in response, for example, to the user's selection of a “Client Funnel” from the main menu. In response, the system 20 is preferably configured to access information regarding the status or phase of each client in the database 24 that corresponds to the user and to display a visual indication of the clients in each phase. FIG. 5 illustrates one such example, where a client status interface includes graphical areas corresponding to each of the “Prospect” 302, “Gathering Data” 304, “Analyze” 306, “Follow Up” 308, “Applicant Submitted” 310, “Delivery” 312, and “Drip Campaign” 314 phases. Further, the system 20 associates an indication of each particular client with its current status or phase. In this configuration, a single interface provides the user with a visual indication of the status of multiple clients. In one embodiment, the user may change the client status by moving the client from one phase to another, such as by dropping and dragging a client from one phase to another in the “Client Funnel” interface.

In one embodiment, the client phases might include one more phases which are not displayed by the “Client Funnel” interface. For example, the client status or phase designators might comprise a “Lost” or “Dead” status, which when indicated by the user causes the client's information to remain stored in the system 20, but prevents the client from showing up as an active client, such as relative to appointments/reminders, in the Client Funnel or the like (effectively “archiving” the client).

As indicated, in one embodiment, the user may change the status or phase of each client. In other embodiments, the system 20 might be configured to do so, such as based upon defined criteria. These criteria may differ for each status or phase, and include time-related criteria and/or other criteria. For example, a client might be placed into the “Gathering Data” phase during the time that the system 20 detects that the user is inputting information regarding the client. The status of that client might only change to “Analyze” when the system 20 either detects that all of the client information has been submitted (e.g. such as by filling out the various input fields associated with the “New Client” interfaces) or by input of a completion indication by the user. Of course, the criteria for each status or phase may differ.

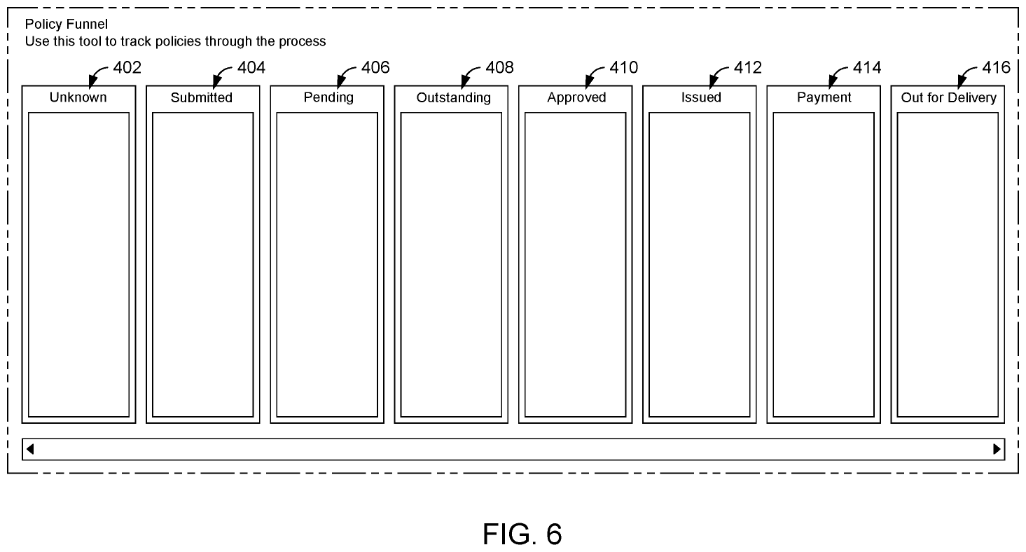

As indicated above and indicated at step S4 of FIG. 2, a user may input information into the system 20 to cause the system to generate a new policy for a client. In one embodiment, the status or phase of that policy may be indicated, and may change over time. Thus, similar to the status of a client, as indicated at step S5c of FIG. 2, the system 20 is configured to generate and cause a user's device to display a graphical indication of the status or phase of policies of different clients in a single view. This view might be displayed in response, for example, to the user's selection of a “Policies Funnel” option from the main menu. In response, the system 20 is preferably configured to access information regarding the status or phase of each policy in the database 24 that corresponds to the user and to display a visual indication of the policies in each phase. FIG. 6 illustrated one such example, where a policy status interface includes graphical areas corresponding to each of an “Unknown” 402, “Submitted” 404, “Pending” 406, “Approved” 410, “Issued” 412, “Payment” 414 and “Out for Delivery” 416 phase. Further, the system 22 associates an indication of each particular policy with its current status or phase. In this configuration, a single interface provides the user with a visual indication of the status of multiple client policies.

One again, in one configuration, the status or phase of each policy might be input or selected by the user, or might be determined by the system 20, such as based upon defined criteria, such as for each phase.

The method and system may have various additional features. For example, the user may, via the system 20 (e.g. without moving to an external interface or program), generate client correspondence, such as by generating and sending one or more emails (or other forms of electronic communication). For example, by selecting a settings option 200n (see FIG. 4), the server 22 might cause the user's device to display an emails interface, such as illustrated at P20 of Appendix A.

In a preferred embodiment, client information may be stored in one or more files or folders. For example, generated proposals, associated insurance or other financial policies or accounts, may be stored in association with client files or folders which are accessible via one or more of the interfaces which are generated by the server 22. This allows a user to archive and access, from the system 20, client files at any time. In one embodiment, such a configuration may be via integration with Microsoft SharePoint. For example, by selecting a “Files” option via the settings option 200n, the server 22 might cause the user's device to display a files interface, such as illustrated at P21 of Appendix A. Such an interface may allow the user to create a new folder, upload files or data to a folder, and may, as illustrated, display a list of folders (such as identified by client names). As indicated, this allows a user to access client files and associated data that is stored in a remote storage (such as at a cloud server) via same application and interfaces as which enables the other functionality described herein.

The user might also request the generation and transmission of a hospitality, such as a gift. For example, by selecting a hospitality option via the settings option 200n, the server 22 might cause the user's device to display a hospitalities interface, such as illustrated at P22 of Appendix A. Such an interface may allow the user to select or input a type of gift and a date to be sent, such as for causing the server 22 to either generate a reminder of the gift to be sent (at the designated time) or for interfacing with one more third parties system to request/order such a gift for shipping and delivery to the client.

The settings option 200a might also include a marketing option which, when selected, cause the server 22 to generate a marketing options interface, such as illustrated at P23 of Appendix A. Such an interface may allow the user to select or input specific marketing preferences for the client. Of course, these marketing preferences may be different for each client and are preferably stored in association with the client in the database. In one embodiment, the system 20 may be configured to generate and send, such as using stored client contact information, marketing materials or other messages. Such might comprise automatically generated emails or text messages (such as based upon particular events, such as a birthday as designated by the client's birthdate as input into the system 22, a policy anniversary, etc.).

As illustrated at P24 of Appendix A, the selection of a Tags option (such as from the settings option 200n) may allow the user to create tags and assign a user to a tag. Such a tag may comprise a designator for the client or for linking multiple clients (such as for ease of identifying and tracking linked clients, such as clients who are all members of a group, etc.).

The method and system preferably allow a user to set appointment or reminders for each client, such as by selecting the appointments object 204 (such as illustrated in FIG. 4). In one embodiment, a reminder may be displayed to the user at the designated date/time of the appointment, and appointments with particular clients may be transmitted to the client, such as by text or email message. In one embodiment, appointments or reminders for clients are preferably indicated relative to clients in the “Client Funnel” interface. In one embodiment, the appointments or reminders might include one or more indicators, such as a visual color indicator which indicates whether the appointment or reminder is coming due, due or past due.

As illustrated in FIG. 3, a user may be permitted to select an “Existing Clients” option 104c such as from the main menu 101. The selection of this option may cause the server 22 to cause the user's device 26 to display a graphical interface which includes information regarding existing clients. In one embodiment, the user may select an “edit” “overview” or “proposals” option to cause other interfaces to be displayed, such as the Client Details interface (such as illustrated in FIG. 4), one or more stored proposals to be displayed, etc. As illustrated, in one embodiment, the existing client information may include information regarding the client's phase or status. One example of such an interface is provided a P25 of Appendix A.

As indicated above, the main menu 101 may include other options, such as a Tools 108 and a Reports 110 option. Selection of the Tools 108 option may cause the server 22 to generate one or more graphical interfaces or other information relating to one or more tools. Likewise, selection of the Reports 110 option may cause the server 22 to generate one or more graphical interfaces or other information, such as which allow the user to request one or more reports relating to stored information.

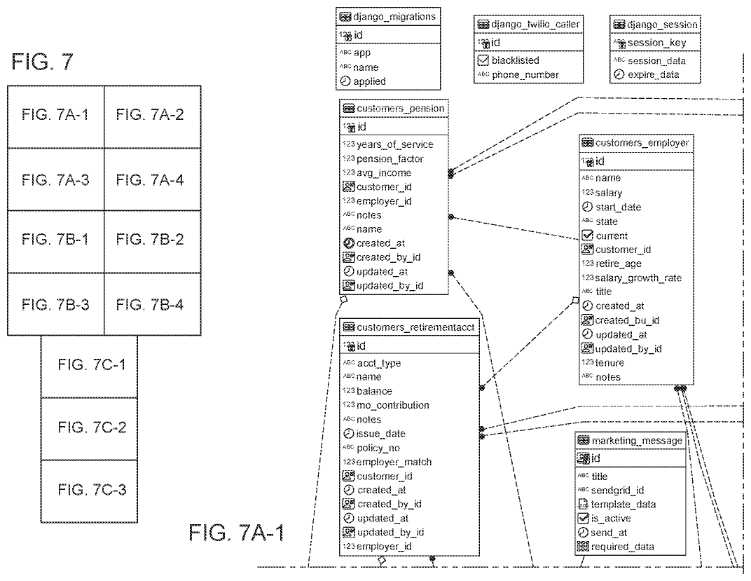

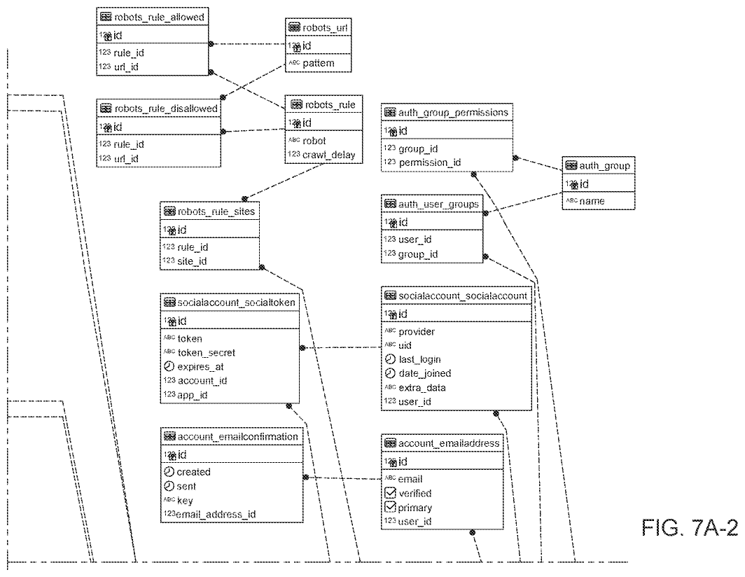

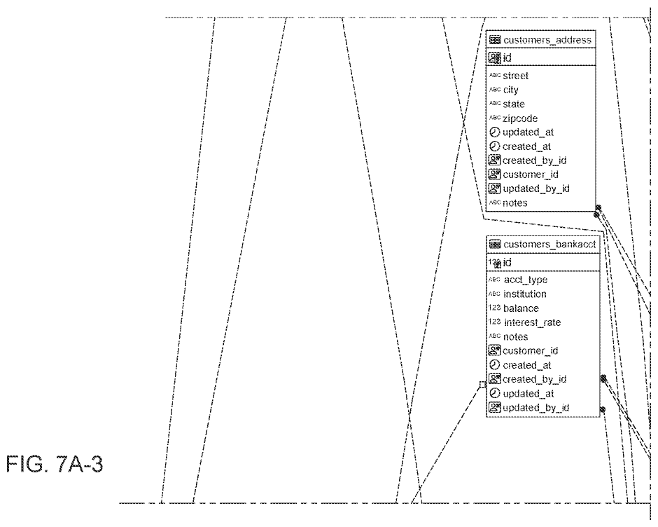

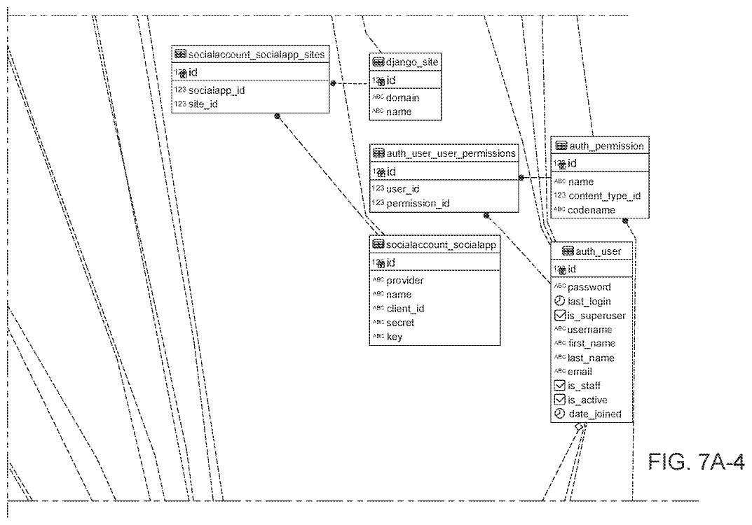

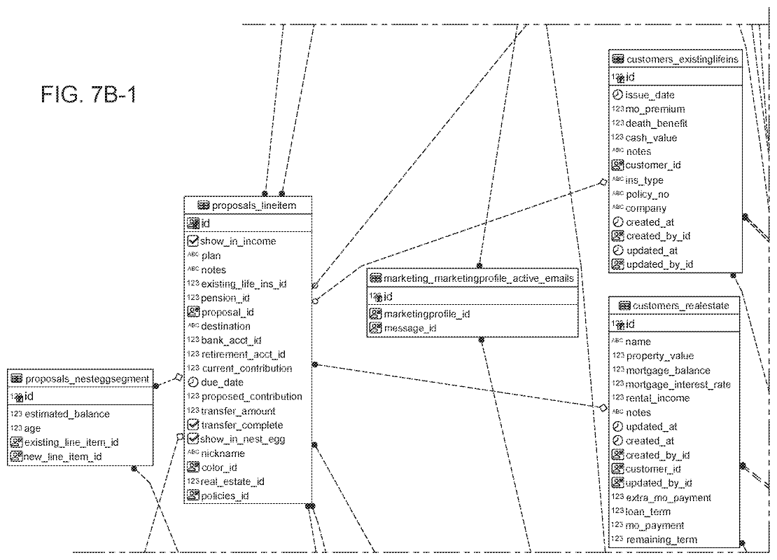

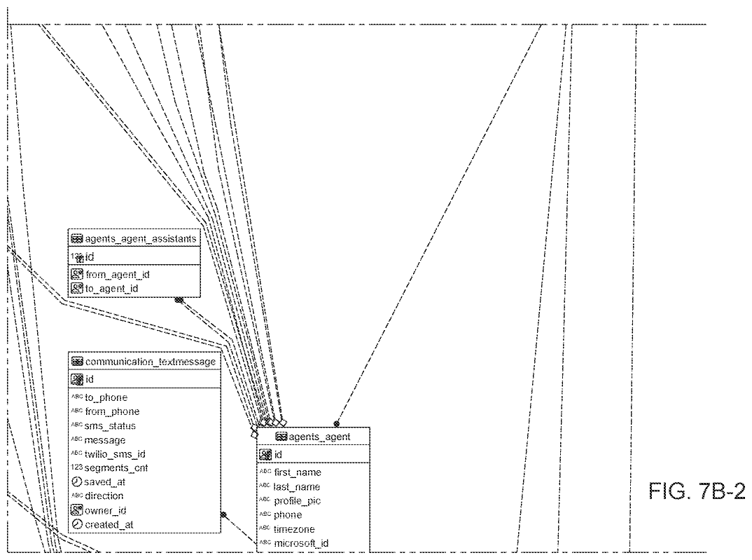

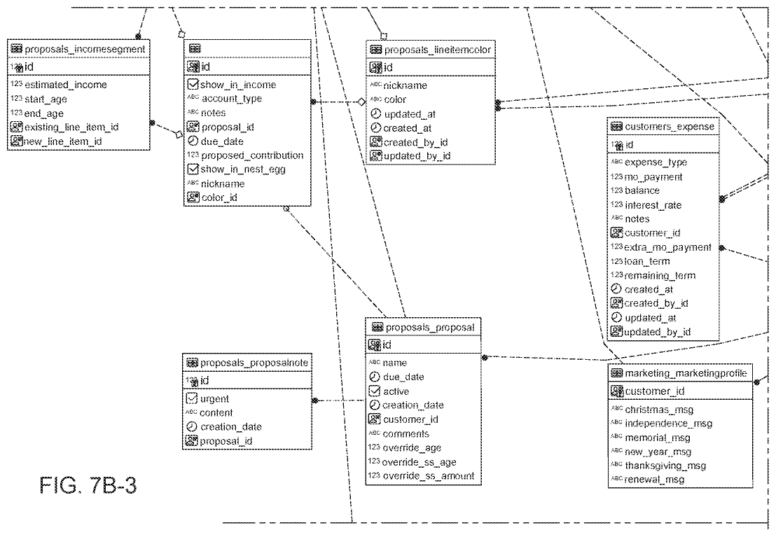

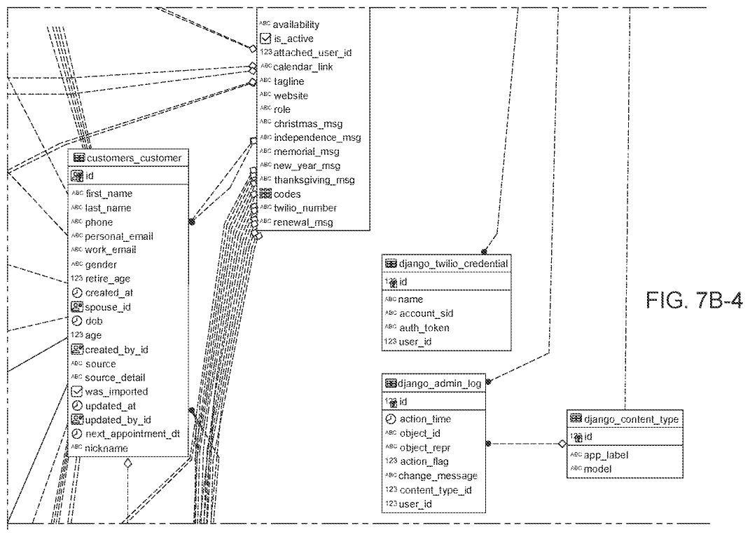

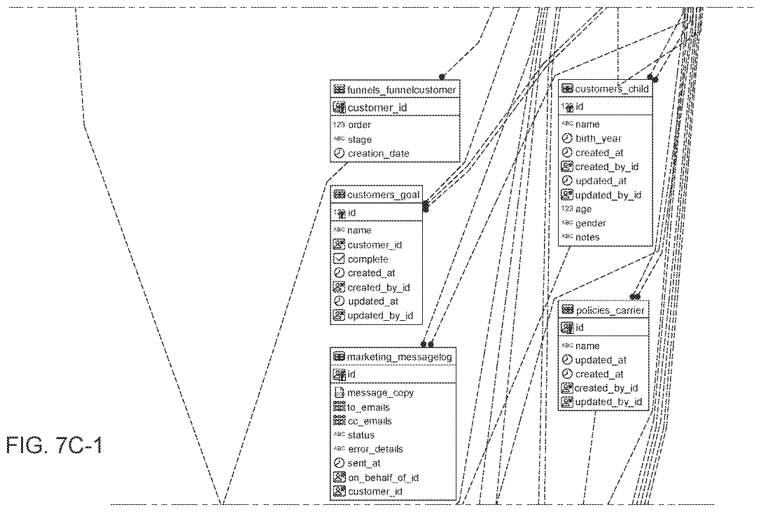

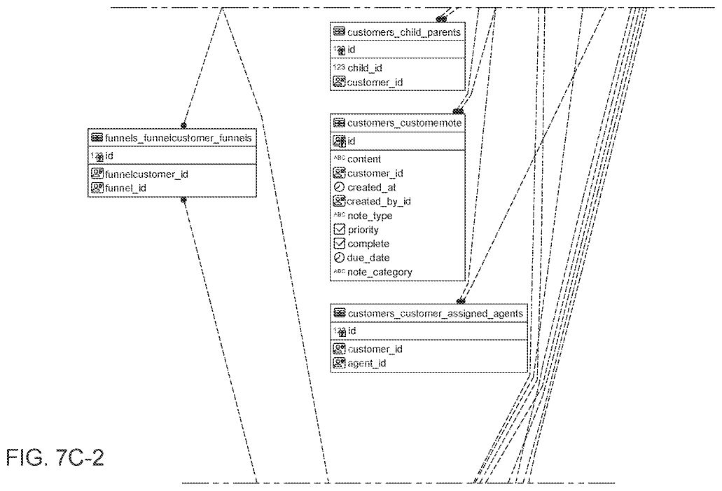

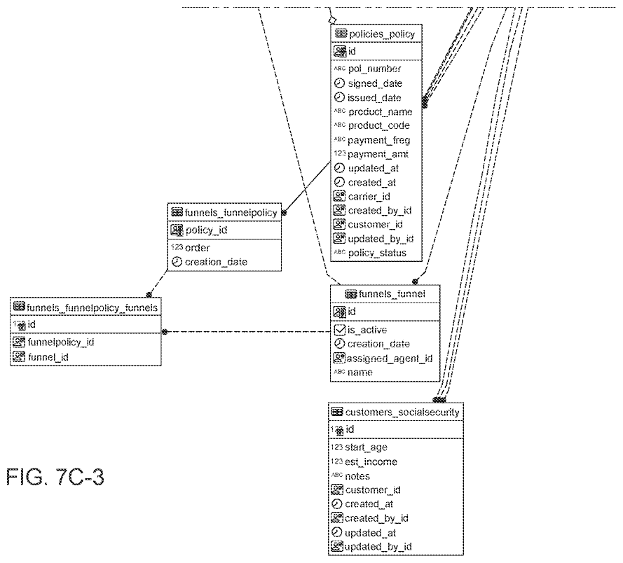

One aspect of the invention is a unique data structure or database which cross-links client-related data. One example of such a database structure is illustrated in FIGS. 7A-C. In one embodiment, individual aspects of the client information may be stored in different data tables, which data tables are then cross-linked. For example, the client's identification information may be stored in a first data table, their pension information in another, their real estate information in another, their bank account information in yet another, etc.

The invention has numerous advantages and solves various problems associated with the prior art. Importantly, the method and system of the invention allows a user to, in an integrated platform: 1) collect, manage and store client identity information; 2) collect, manage and store client financial and insurance information (as linked to the client identity information); 3) track, from inception to end, the interaction with the client, including from prospect through servicing of the client; 4) generate and present client-related information, such as client financial and insurance proposals; and 5) communicate with clients.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. An integrated client tracking and finance generation system comprising:
a management platform, said management platform comprising at least one server and a data storage device, said server comprising a communication interface for establishing a communication link with at least one user device having a display device, said management platform further comprising a processor, a memory and machine readable code stored in said memory and executable by said processor to cause said server to:
receive information regarding a plurality of clients, said information comprising, as to each of said plurality of clients, client identity information, client status information and client financial information regarding a plurality of client financial accounts;
store, in a database associated with said data storage device, said information regarding said plurality of clients, in electronic format;
generate information for causing said display device of said user device to display a graphical user interface indicating a plurality of client phases and an indication of each client with a respective one of said phases based upon the client status information for each client; and
implement a financial engine, said financial engine configured to:
receive input of a selection of at least one of said clients;
access financial data regarding said plurality of financial accounts of said client; and
generate information for causing said display device of said user device to display a graphical user interface comprising at least one graphical indicator of financial amounts associated with said plurality of accounts of said client.

2. The system in accordance with claim 1, wherein said financial accounts comprise bank accounts, retirement accounts and/or insurance policies.

3. The system in accordance with claim 1, wherein said graphical indicator of financial amounts comprises a graphical indicator of income from a plurality of different sources, wherein an amount of income from each source is independently indicated and selectable.

4. The system in accordance with claim 3, wherein said income sources are independently indicated by a different color indicator.

5. The system in accordance with claim 1, wherein said at least one of said clients comprises a client and spouse.

6. The system in accordance with claim 1, wherein said phases are defined by a status of said client in relation to a business.

7. The system in accordance with claim 1, wherein said server is further configured to implement a communication engine by which said user may generate and send, via a client interface, at least one electronic communication to said client.

8. The system in accordance with claim 1, wherein said client status is automatically updated by said server.

9. The system in accordance with claim 1, wherein said client status is input by said user.

10. The system in accordance with claim 1, wherein the step of receiving client financial information comprises establishing a communication interface between said server and an external financial platform for receiving real-time financial information regarding said client.

11. The system in accordance with claim 1, wherein said real-time financial information comprises an account balance.

12. The system in accordance with claim 1, wherein said server is further configured to generate at least one financial proposal based at least in part upon said stored client financial information.

13. The system in accordance with claim 1, wherein said client identity information is stored in a least one first data table and said client financial information is stored in at least one second data datable, said first data table linked to said second data table.

14. The system in accordance with claim 13, wherein at least one identifier is common to both said first data table and said second data table.

15. The system in accordance with claim 1, wherein said financial engine is configured to transform said client financial information into a graphical interface.

16. The system in accordance with claim 1, wherein said server is configured to associate a client identifier with said client, wherein said plurality of client phases are indicated by a plurality of graphically indicated regions and wherein said server is configured to cause said graphical user interface to display said client identifier in association with one of said graphically indicated regions.
